(19) United States
(12) Patent Application Publication
(10) Pub. No.: US 2021/0219571 A1
(43) Pub. Date: Jul. 22, 2021

(54) METHODS OF INCORPORATING SUSTAINABLE CARBON SUPPLEMENTS INTO ANIMAL FEED

(71) Applicant: John Murray Minnema, Visalia, CA (US)

(72) Inventor: John Murray Minnema, Visalia, CA (US)

(21) Appl. No.: 17/153,693

(22) Filed: Jan. 20, 2021

Related U.S. Application Data
(60) Provisional application No. 62/963,869, filed on Jan. 21, 2020.
(60) Provisional application No. 62/968,590, filed on Jan. 31, 2020.

(51) Int. Cl. A23K 10/37; C10B 53/02; A23K 10/16; A23K 20/28; A23K 50/10

(52) U.S. Cl. CPC A23K 10/37; C10B 53/02; A23K 50/10; A23K 20/28; A23K 10/16

(57) ABSTRACT

The embodiments herein are directed to methods for incorporating high quality, sustainable carbon product into animal feed. In particular, the sustainable carbon product described herein for use in animal feed may be produced as byproducts of efficient, clean energy processes. Utilization of sustainable carbon product produced by such clean energy solutions can provide long-term benefits to the environment, while providing a high quality feed supplement for detoxification of animals.

### INCORPORATION BY REFERENCE TO ANY PRIORITY APPLICATIONS

This application claims priority benefit of U.S. Provisional patent Application No. 62/963,869, filed Jan. 21, 2020 and titled, “METHODS OF INCORPORATING SUSTAINABLE BIOCHAR SUPPLEMENTS INTO ANIMAL FEED”, and U.S. Provisional Patent Application No. 62/968,590, filed Jan. 31, 2020 and titled, “METHODS OF INCORPORATING SUSTAINABLE BIOCHAR SUPPLEMENTS INTO ANIMAL FEED”, each of which is incorporated herein by reference in its entirety.

Any and all applications for which a foreign or domestic priority claim is identified in the Application Data Sheet as filed with the present application are hereby incorporated by reference under 37 CFR 1.57.

### BACKGROUND

### Field

The present disclosure relates to animal feeds, and particularly, methods of incorporating Sustainable carbon product into animal feeds.

### Description

Various carbon products such as activated carbon and activated charcoal are considered useful as poison antidotes for livestock animals. Activated carbon may be obtained from a wide variety of sources and is activated by a number of different processes. Activated carbon is distinguished from elemental carbon by the removal of all non-carbon impurities and the oxidation of the carbon surface.

Because animals are increasingly subjected to contaminated water and feed, some farmers follow a practice of mixing charcoal or other activated carbons into either drinking water or animal feed. Commercially available activated charcoals specifically designed to be added to cattle and poultry feed are able to adsorb many toxins from water-borne organisms or toxins from decomposing feeds. An added benefit is the marked reduction in waste odors.

Activated carbon can be prepared from a large number of sources by a wide variety of methods. Traditionally, there have been four basic forms of activated carbon: Animal charcoal is obtained by charring animal bones, meat, blood, etc.; Gas black, furnace black, or channel black is obtained by the incomplete combustion of natural gas; Lamp black is obtained by the burning various fats, oils, resins, etc.; and Activated charcoal is prepared from wood and vegetables.

Currently, carbon products for animal feed is mainly prepared with the pyrolysis of carbonaceous raw materials. The environmental impact associated with a specific activated carbon varies because activated carbon can be produced from various carbonaceous materials by physical or chemical activation, or by a combination of the two processes. However, generally, the production of activated carbon produces harmful byproducts and a net carbon negative effect. Additionally, some activated carbons, including activated charcoal, are expensive to produce or not available in sufficient quantities and thus are not ideal for animal feed. Finally, activated carbons and activated charcoal products have been limited to therapeutic use of diagnosed toxicity and prohibited from routine feeding of livestock in the absence of poisoning. This is because mass production and use of activated carbons in feedstock would result in increased risk of detrimental chemical reactions in organic farming systems, as well as a high probability of environmental contamination. Furthermore, activated carbons/charcoals may cause respiratory problems for humans who handle the substance. Thus, new, safe, sustainable, and lawfully permissible methods of supplementing animal feeds that reduce the net environmental impact and costs of producing and utilizing carbon products are needed.

### SUMMARY

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

In some aspects, a method for supplementing animal feed using a sustainable carbon product is provided, the method comprising: obtaining the sustainable carbon product from a process comprising: obtaining a biomass feedstock; feeding the biomass feedstock to a gasification or pyrolysis system; and gasifying or pyrolyzing the biomass feedstock in the gasification or pyrolysis system to produce a gas and the sustainable carbon product; and adding between 1.0 g and 10.0 g of the sustainable carbon product per day into the animal feed for an animal.

In some embodiments, the biomass comprises softwood, hardwood, nut shells, coconut shell, or hemp. In some embodiments, the sustainable carbon product comprises at least 70% carbon by weight. In some embodiments, the sustainable carbon product comprises at least 85% carbon by weight. In some embodiments, the sustainable carbon product comprises less than 10% ash by weight. In some embodiments, the sustainable carbon product comprises less than 12% H₂O by weight. In some embodiments, the sustainable carbon product comprises a powder having an average particle size of greater than 70 microns or less than 40 microns. In some embodiments, the sustainable carbon product comprises one or more of hydrogen, nitrogen, sulfur and oxygen. In some embodiments, the sustainable carbon product comprises substantially no heavy metals or pesticides.

In some embodiments, the process comprises a carbon neutral or carbon positive process. In some embodiments, the method further comprises adding electrolytes to the obtained sustainable carbon product with prior to adding the sustainable carbon product into the animal feed. In some embodiments, the gasifying or pyrolyzing the biomass feedstock comprises exposing the biomass feedstock to a temperature above 700° C. substantially in the absence of oxygen or air. In some embodiments, the method further comprises separating the gas and the sustainable carbon product. In some embodiments, the method further comprises adding bentonite to the sustainable carbon product prior to adding the sustainable carbon product into the animal feed. In some embodiments, the method further comprises adding one or more of probiotics, Xantham gum, potassium sorbate, and water to the sustainable carbon product prior to adding the sustainable carbon product into the animal feed.

In some embodiments, the animal feed comprises a communal or pooled animal feed for a plurality of animals and between 1.0 g and 10.0 g of the sustainable carbon product is added to the animal feed per animal per day. In some embodiments, the animal feed comprises an individual animal feed for a single animal and 1.0 g to 10.0 g of the sustainable carbon product is added to the animal feed per day. In some embodiments, the animal comprises an animal from the biological subfamily Bovinae. In some embodiments, the animal comprises a cow. In some embodiments, the animal comprises a lactating animal or an animal less than 150 days old.

In some embodiments, between 1.0 g and 10.0 g of the sustainable carbon product is added per day into the animal feed for the animal for between 20 and 30 days after birth of the animal. In some embodiments, the pre-mixed sustainable carbon product is added into the animal feed by pre-mixing such as to provide a uniform mix of the sustainable carbon product and the animal feed.

In some aspects, a sustainable carbon product formulation suitable for use as a feed additive for animal feed is provided, the sustainable carbon product formulation comprising: a sustainable carbon product formed from a process comprising: obtaining a biomass feedstock; feeding the biomass feedstock to a gasifier system; and gasifying the biomass feedstock to produce hydrogen and the sustainable carbon product; and bentonite powder, wherein the sustainable carbon product formulation comprises a gel. In some embodiments, the sustainable carbon product formulation further comprises one or more of: probiotics, Xantham gum, potassium sorbate, and water.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates a flowchart of an exemplary method for supplementing animal feedstock using a sustainable carbon product as described herein.

FIG. 2 illustrates a table showing results for neutral detergent fiber (NDF), total volatile fatty acid (VFA), VFA profile, and gas production for a study of the effects of sustainable carbon product supplementation on microbial fermentation.

FIG. 3 illustrates a chart showing NDF disappearance results for a study of the effects of sustainable carbon product supplementation on microbial fermentation.

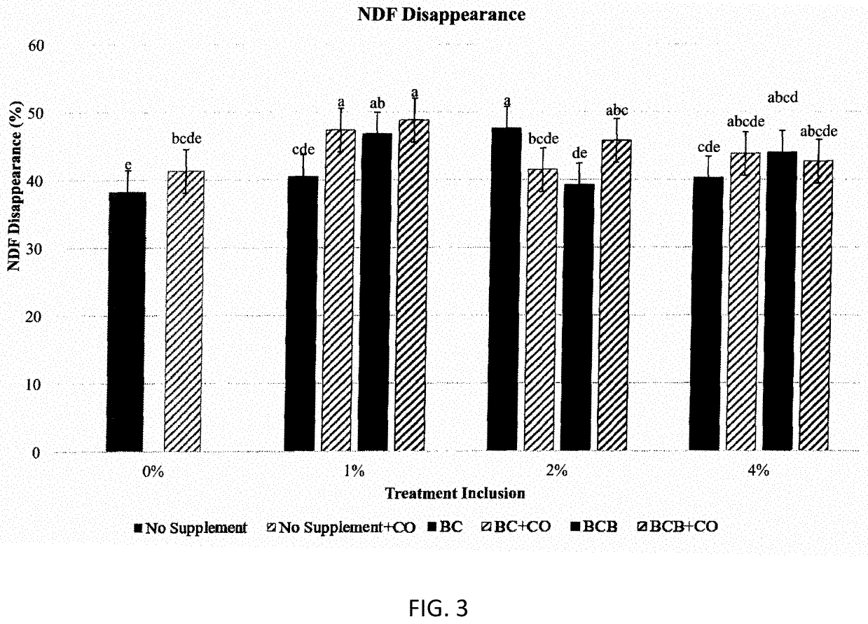

FIG. 4 illustrates a chart showing total VFA concentration results for a study of the effects of sustainable carbon product supplementation on microbial fermentation.

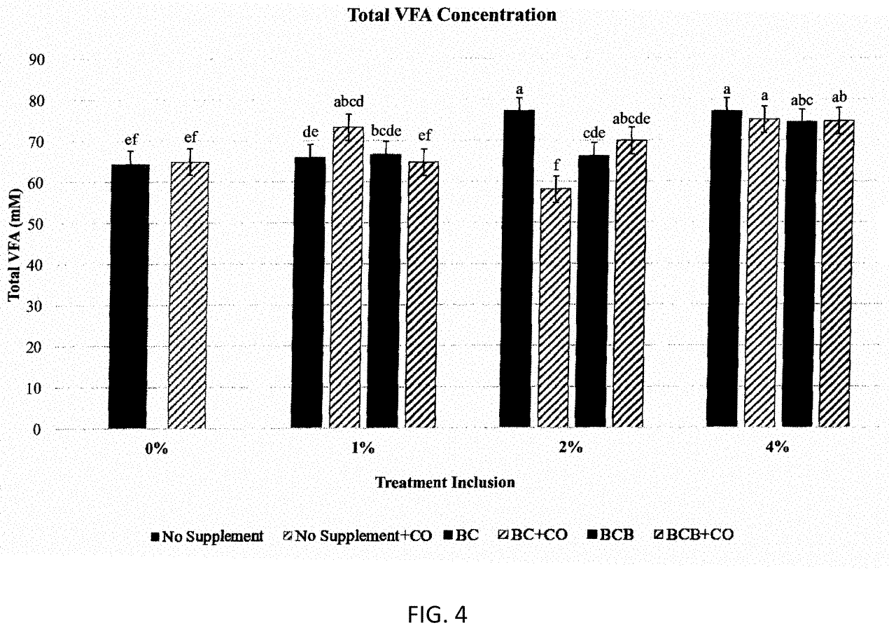

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Some embodiments herein are directed to methods for routinely incorporating high quality, sustainable carbon product into animal feed. In particular, the sustainable carbon product described herein for use in animal feed may be produced as byproducts of efficient, clean energy processes. Utilization of sustainable carbon product produced by such clean energy solutions can provide long-term benefits to the environment, while providing a high quality feed supplement for detoxification of animals. As used herein, animals refer to any organisms that form the biological kingdom Animalia. Although the embodiments herein are generally described with respect to cattle or other domesticated animals, the embodiments are not limited as such.

As used herein, sustainable carbon product is a carbonaceous material comprised almost exclusively of pure carbon. Size of particles range from pellets to fine particles. Sustainable carbon product is produced from a variety of feedstock including, for example, pine wood, almond shells and hulls, pistachio shells, walnut shells. The feedstock may be a mixture of different biomass materials. Sustainable carbon product may be made through a pyrolysis/gasification production process. Sustainable carbon product may contain over 70%, or more preferably over 85% carbon, but also hydrogen, nitrogen, sulfur and oxygen. Sustainable carbon product may also comprise less than 10% ash and less than 10% water.

As used herein, sustainable carbon product may comprise very low or no amount of heavy metals or pesticides. As used herein for the purpose of incorporation into animal feed, sustainable carbon product comprises a carbon-based material made of substantially pure carbon. As used herein, sustainable carbon product may be produced from softwood, hardwood, nutshells, coconut shells, hemp, or a combination of a variety of substrates, including those listed above. In some embodiments, sustainable carbon product may comprise over 70% carbonized biomass, less than 10% ash, and less than 12% water (H₂O).

In some embodiments, sustainable carbon product comprises a carbon product suitable as a feed additive for animals. In some embodiments, sustainable carbon product may be formed in size ranges such as to form pellets, shells, rough ground (e.g. >70 microns) powder, to fine ground (40 microns or less) powder. In some embodiments, sustainable carbon product mat comprise a moisture content of less than 10%. The bulk density of sustainable carbon product may vary from around 0.01 g/cm to about 10 g/cm. For example, the bulk density of sustainable carbon product used in the methods herein may be about 0 g/cm, about 0.5 g/cm, about 1 g/cm, about 1.5 g/cm, about 2 g/cm, about 2.5 g/cm, about 3 g/cm, about 3.5 g/cm, about 4 g/cm, about 4.5 g/cm, about 5 g/cm, about 5.5 g/cm, about 6 g/cm, about 6.5 g/cm, about 7 g/cm, about 7.5 g/cm, about 8 g/cm, about 8.5 g/cm, about 9 g/cm, about 9.5 g/cm, about 10 g/cm, or any value between the aforementioned values. In some embodiments, the bulk density of sustainable carbon product may be about 0.42 g/cm. In some embodiments, sustainable carbon product may be water insoluble and have a pH between about 6 and about 10. In some embodiments, the melting point of sustainable carbon product may be about 3,500° C.

In some embodiments, sustainable carbon product may comprise a surface area of about 250 m²/g. In some embodiments, sustainable carbon product may comprise a surface area between about 1 m²/g to about 1000 m²/g. For example, in some embodiments, sustainable carbon product may comprise a surface area of about 1 m²/g, about 50 m²/g, about 100 m²/g, about 150 m²/g, about 200 m²/g, about 250 m²/g, about 300 m²/g, about 350 m²/g, about 400 m²/g, about 450 m²/g, about 500 m²/g, about 550 m²/g, about 600 m²/g, about 650 m²/g, about 700 m²/g, about 750 m²/g, about 800 m²/g, about 850 m²/g, about 900 m²/g, about 950 m²/g, about 1000 m²/g, or any value between the aforementioned values.

In some embodiments, sustainable carbon product may comprise a biochar product made suitable for agricultural applications. In some embodiments, size of sustainable carbon product particles range from pellets to fine powder of less than 325 mesh. In some embodiments, the moisture content of the sustainable carbon product may be less than 10%, or less than 5%. In some embodiments, the sustainable carbon product may have a bulk density around 0.42 g/cm³ uncompacted. Sustainable carbon product is generally not soluble in water and has a pH ranging from around 6 to around 10. In some embodiments, sustainable carbon product may have a melting point around 3500° C. and is stable under normal environmental conditions. In some embodiments, sustainable carbon product may be incompatible with chlorine, acids, ozone, and liquid oxygen. In some embodiments, sustainable carbon product may not be toxic to humans or animals.

In some embodiments, the sustainable carbon product feed supplements described herein may be produced as a byproduct of electricity generation. For example, commercially available equipment can convert biomass (e.g. agricultural waste) to electricity and are capable of producing sustainable carbon product as a byproduct, while decreasing or mitigating methane or other greenhouse gas emission.

The environmental and contaminating effects of sustainable carbon product use as described herein may be minimal. The sustainable carbon product may be a byproduct of a carbon neutral or minimally carbon negative process. For example, gasification using biomass may be used to produce sustainable carbon product and is desirable from the point of view of decreasing greenhouse emissions, as biomass use is essentially a carbon neutral process if all the biomass is used, and can be a minimally carbon negative process if some carbon is sequestered. Due to its portability and widespread availability, biomass is used extensively in small-scale gasification systems.

Furthermore, once consumed by animals, the sustainable carbon product may interact to adsorb and neutralize other toxic materials. Any detrimental interaction with other materials would result from the concentration of these substances in the feces of treated animals. Proper manure management and composting should be able to mitigate or eliminate the detrimental chemical interactions resulting from treatment. Furthermore, once consumed by animals, the sustainable carbon product may result in a decrease in methane production in vitro. In some embodiments, the sustainable carbon product may be supplemented with electrolytes or other supplements when used in animal feedstock.

### Gasification Process for Producing Biomass

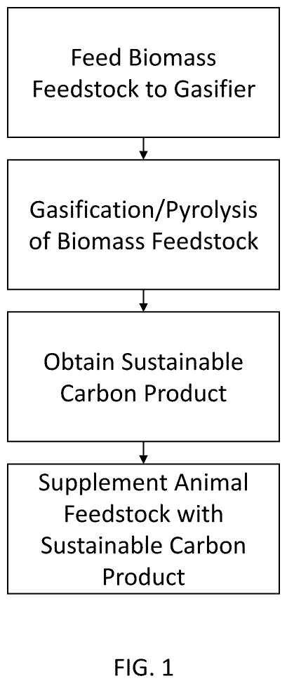

In some embodiments, sustainable carbon product feed may be obtained as a byproduct of a biomass gasification process. FIG. 1 illustrates a flowchart of an exemplary method for supplementing animal feedstock using a sustainable carbon product as described herein.

As used herein, biomass refers to a renewable organic resource, including, for example, agriculture crop residues (e.g. corn stover or wheat straw), forest residues, special crops grown specifically for energy use (e.g. switch grass or willow trees), organic municipal solid waste, and animal wastes. This renewable resource can be used to produce hydrogen, along with other byproducts, by gasification. Biomass is an ideal feedstock for energy generation processes as there is more biomass available than is required for food and animal feed needs. Furthermore, plants consume carbon dioxide from the atmosphere as part of their natural growth process as they make biomass, off-setting the carbon dioxide released from producing hydrogen through biomass gasification and resulting in low net greenhouse gas emissions. In some embodiments, sustainable carbon product may be formed as a byproduct of pyrolysis by burning green waste or biomass for carbon sequestering.

Pyrolysis, gasification and plasma technologies are thermal processes that use high temperatures to break down waste. The main difference between the above processes and incineration is that they use less oxygen than traditional incineration. The above processes are sometimes referred to as Advanced Thermal Technologies or Alternative Conversion Technologies. Pyrolysis and gasification typically rely on carbon-based waste such as paper, petroleum-based wastes like plastics, and organic materials such as food scraps or other biomass. In some embodiments, biomass is broken down to create gas, solid and liquid residues. In some embodiments, the gas products can be combusted in a secondary process. A pyrolysis process thermally degrades waste in the absence of oxygen and/or air. A Gasification process exposes materials to some amount of oxygen, but not enough to allow combustion to occur. In some embodiments, temperatures may be maintained above 700° C. In some embodiments, the pyrolysis phase is followed by one or more additional gasification stages, which remove additional energy carrying gases, which are liberated from the input. In some embodiments, the main product of gasification and pyrolysis is syngas, which is composed mainly of carbon monoxide and hydrogen, with smaller quantities of carbon dioxide, nitrogen, methane and various other hydrocarbon gases.

In some embodiments, gasification and pyrolysis used herein may involve separate steps comprising preparation of a feedstock, heating the feedstock, and separating the products. In some embodiments, the feedstock may comprise biomass or be in the form of a refuse-derived fuel, produced by a mechanical biological treatment plant or an autoclave. Alternatively, the feedstock may comprise waste processed through a materials recycling process, to remove some recyclables and materials that have no calorific value (e.g. grit). In some embodiments, heating the feedstock in a low-oxygen atmosphere produces a gas, oil and sustainable carbon product. The sustainable carbon product byproduct may be used to supplement feedstock according to various embodiments herein.

In some embodiments, biomass gasification is a process that converts biomass at high temperatures (>700° C.), with a controlled amount of oxygen and/or steam into carbon monoxide, hydrogen, and carbon dioxide. The carbon monoxide then reacts with water to form carbon dioxide and more hydrogen via a water-gas shift reaction. Adsorbers or special membranes can separate the hydrogen from this gas stream. A simplified biomass gasification reaction may comprise C₆H₁₂O₆+O₂+H₂O→CO+CO₂+H₂+other species (e.g. carbon residue or sustainable carbon product).

As used herein, pyrolysis is the gasification of biomass in the substantial absence of oxygen. In general, biomass does not gasify as easily as coal, and it produces other hydrocarbon compounds in the gas mixture exiting the gasifier; this is especially true when no oxygen is used. As a result, typically an extra step must be taken to reform these hydrocarbons with a catalyst to yield a clean syngas mixture of hydrogen, carbon monoxide, and carbon dioxide. Then, just as in the gasification process for hydrogen production, a shift reaction step (with steam) converts the carbon monoxide to carbon dioxide. The hydrogen produced can then be separated and purified. A simplified water-gas shift reaction may comprise CO+H₂O→CO₂+H₂+heat.

While syngas, a mixture of CO, H₂, and other hydrocarbons, is considered to be the main product of the biomass gasification process and is used in electricity generation, a byproduct of the biomass gasification process is a carbon residue or sustainable carbon product, which may be a precursor to activated carbon. This carbon residue or sustainable carbon product is created when the biomass feedstock decomposes, lowers its density, and increases its porosity during gasification.

Utilization of sustainable carbon product produced as a byproduct by the above gasification processes may provide the benefit of decreased methane generation. For example, in some embodiments, methane production may be reduced by around 25% relative to other carbon product generation processes. Additionally, carbon credits or other tradeable certificates or permits may be obtained because of the reduced carbon dioxide generation associated with gasification processes.

### Incorporation of Sustainable Carbon Product in Animal Feed

In some embodiments, sustainable carbon product produced by biomass gasification may be used as a component of animal feed to detoxify and provide additional health benefits to animals. In some embodiments, the sustainable carbon product may be used as feed supplement for animal feed, such that it is provided within a communal, pooled, or individual animal feed.

One problem in the raising of livestock or poultry is the presence of aflatoxins in animal feed. Aflatoxins are poisonous byproducts of the growth of some species of the mold fungus Aspergillus. Some crops may be contaminated with aflatoxins, particularly whenever drought stress occurs. When lactating animals are fed aflatoxin contaminated feed, they excrete aflatoxin metabolites into their milk. The aflatoxins are capable of causing aflatoxicosis in consumers of milk. Aflatoxicosis is a disease caused by the consumption of aflatoxins, the mold metabolites produced by some strains of Aspergillus flavus and Aspergillus parasitisus. The four most common aflatoxins are B1, B2, G1 and G2.

Dairy and beef cattle are more susceptible to aflatoxicosis than sheep. Young animals of all species are more susceptible to the effects of aflatoxins than mature animals. Pregnant and growing animals are less susceptible than young animals but more susceptible than mature animals. Aflatoxicosis may cause feed refusal, reduced growth rate, decreased milk production and decreased feed efficiency. In addition, listlessness, weight loss, rough hair coat and mild diarrhea may occur. Anemia along with bruises and subcutaneous hemorrhage are also symptoms. The disease may also impair reproductive efficiency, including abnormal estrous cycles. Other symptoms include impaired immune response, increased susceptibility to other diseases and rectal prolapse. In dairy cattle, aflatoxin metabolites appear in the milk before any of the above signs develop.

In some embodiments, sustainable carbon product can be used to prevent and treat aflatoxin contamination in livestock or poultry, resulting in enhanced animal health and productivity (e.g. increased milk production and/or increased weight). Sustainable carbon product produced and incorporated into animal feed by the methods described herein may be effective in removing various mycotoxins, such as aflatoxin, fumonisins, ochratoxin A, trichothenes, and zearalenone. Natural toxins from plants may also be removed or attenuated by sustainable carbon product treatment or supplementation. Sustainable carbon product can also be used to remove synthetic pesticides from animals that might contaminate milk or meat. Treatment with sustainable carbon product when using certain parasiticides can help reduce the residual levels in flesh and fatty tissue. Finally, sustainable carbon product is used to treat animals for drug overdoses.

Sustainable carbon product may be especially useful for treating lactating animals and young animals that are more susceptible to the effects of aflatoxin. For example, young animals, including calves, may depend on colostrum, the first form of milk produced by the mammary glands of mammals just prior to and/or immediately following delivery of a newborn, to maintain healthy growth. Colostrum contains antibodies to protect newborn animals against disease. Furthermore, fat and/or protein concentration in colostrum is generally substantially higher than in milk. Newborn animals have very immature and small digestive systems, and colostrum delivers its nutrients in a very concentrated low-volume form. In some embodiments, for example, bovine calves may need colostrum for about 2 to 30 days after birth to maintain a healthy immune system and level of growth. Failing to provide colostrum to bovine calves for the required period may result in immunodeficiency and unhealthy growth rates.

Since it is very difficult to provide enough colostrum to young animals for the required period, bovine calves are generally transported to calf farms, where they are raised for around 120 to 150 days, or until they reach a weight of about 310 lbs. To ensure that vulnerable calves are protected against toxins, these calf ranches may incorporate sustainable carbon product into the animal feed. This sustainable carbon product, in amount of about 1 to 10 g/calf/day, can be especially useful in the first 20-30 days after birth to protect calves against toxins. In some embodiments, the sustainable carbon product may be provided as a feed supplement in animal feed in the amount of about 4 g/calf/day. For example, the sustainable carbon product may be provided as a feed supplement to calves or other newborn animals in the amount of about 1 g/calf/day, about 1.25 g/calf/day, about 1.5 g/calf/day, about 1.75 g/calf/day, about 2 g/calf/day, about 2.25 g/calf/day, about 2.5 g/calf/day, about 2.75 g/calf/day, about 3 g/calf/day, about 3.25 g/calf/day, about 3.5 g/calf/day, about 3.75 g/calf/day, about 4 g/calf/day, about 4.25 g/calf/day, about 4.5 g/calf/day, about 4.75 g/calf/day, about 5 g/calf/day, about 5.25 g/calf/day, about 5.5 g/calf/day, about 5.75 g/calf/day, about 6 g/calf/day, about 6.25 g/calf/day, about 6.5 g/calf/day, about 6.75 g/calf/day, about 7 g/calf/day, about 7.25 g/calf/day, about 7.5 g/calf/day, about 7.75 g/calf/day, about 8 g/calf/day, about 8.25 g/calf/day, about 8.5 g/calf/day, about 8.75 g/calf/day, about 9 g/calf/day, about 9.25 g/calf/day, about 9.5 g/calf/day, about 9.75 g/calf/day, about 10 g/calf/day, or any value between the aforementioned values.

In some embodiments, sustainable carbon product may be incorporated into milk to be fed to calves in the amount of about 1.5 grams to 3 grams per bottle of milk for calves weighing around 55 lbs. to 80 lbs. In some embodiments, the calves may be fed around 2 bottles of milk per day for the first 20-30 days after birth. In some embodiments, sustainable carbon product may be incorporated into animal feed for adult cows in an amount of about 1.00 oz. to 1.25 oz. per day per cow. In some embodiments, the sustainable carbon product is pre-mixed into the animal feed to provide a uniform, thorough mix of the sustainable carbon product and the feed.

In some embodiments, incorporation of sustainable carbon product into calf animal feed may reduce the incidence of scours by about 50% to 75%. Furthermore, the incorporation of sustainable carbon product into animal feed may reduce the need for the administration of broad-spectrum antibiotics to bovine calves by increasing resistance to toxins and microorganisms. Thus, sustainable carbon product use in animal feed may assist in the prevention of antibiotic resistance.

Sustainable carbon product described herein may be complexed with, e.g., kaolin clay (bolus 149 alba), propylene glycol, and various wetting and dispersing agents. Among the wetting agents and dispersants may be naphthalene sulfonates, alkyl aryl polymers, and triethanolamine, among others. Alternative formulations may use other clays and mined minerals such as bentonite and gypsum, synthetically treated minerals such as dicalcium phosphate and silica gels, vegetable gums, synthetic vegetable derivatives such as sodium carboxymethylcellulose, solvents such as isopropanol, and synthetic suspension polymers such as povidone.

In addition, in some embodiments, the sustainable carbon product may be supplemented with one or more additional ingredients for use as an animal feed supplement. For example, in some embodiments, a sustainable carbon gel formulation may comprise about 75% bentonite, about 25% fine sustainable carbon product, and additional additives comprising probiotics, xanthum gum, potassium sorbate, and/or sterile water.

### EXAMPLES

### Example 1

A study was conducted to determine the effect of adding sustainable carbon product, as described herein, to calf milk replacer diets on diarrhea, disease, overall health and weight gain performance. 40 heifers were tested. A heifer is a female cow that has not had any offspring. All heifers with pre-existing conditions on arrival were excused from the study. All heifers were weighed prior to testing. A skin notch from each heifer was tested for Bovine Viral Diarrhea Virus Persistent Infection (BVD-PI). Blood was drawn from each heifer to determine serum total protein.

Half of the test population received 2 grams of sustainable carbon product per feeding in their milk replacer for 21 days. Typically, calves were fed 2 times per day, resulting in a total ingestion of 4 grams of sustainable carbon product per calf per day. The remaining half of the test population received the same ration of milk with no added carbon product. All illnesses in the heifers were recorded. Heifers that became sick were treated according to farm standard treatment protocols. All heifers that died were necropsied to determine a cause of death. All of the heifers calves were weighed 6 weeks after initiation of testing.

A final report was generated to compare the health and performance of the two groups of heifers. The effect of the sustainable carbon product on number of calves with diarrhea and the duration and severity of the disease was determined. The amount of overall sickness was determined for each population group. The average and total weight gained in each group was recorded and compared.

48 calves were received, weighed and examined for inclusion into study. All calves were ear notched and determined to be BVD Negative by an ELISA test. One calf from each shipment was excluded based on a preliminary physical examination, leaving 46 to be equally divided into two groups of 23 for a treatment group and a control group. Calves were assigned to their respective group based on average weight. Calves were managed in the same manner, with the only exception being the addition of sustainable carbon product at 2 grams per head per feeding for the first 21 days. After 21 days, the additional sustainable carbon product was removed from the milk replacer feedings and all calves were fed in identical manner until weaning. Daily observations and individual calf treatments were recorded from day 1 until calves were weaned at day 42, and each calve was weighed again at day 42 and assigned into group pens for post-weaning analysis.

Average weights in and weights out (in pounds), weight gains, and average daily gain (ADG) are summarized in Table 1.

TABLE 1

| Sustainable | | | | No Sustainable | | | |
|---|---|---|---|---|---|---|---|
| Carbon | | | | Carbon | | | |
| Product | | | | Product | | | |
| Avg. | Avg. | Avg. | Avg. | Avg. | Avg. | Avg. | Avg. |
| In | Out | Gain | ADG | In | Out | Gain | ADG |
| 96.26 | 160.9 | 64.7 | 1.539 | 96.17 | 155.6 | 59.4 | 1.414 |
| 0.1% | 3.4% | 8.9% | 8.8% | | | | |

Further analysis of the top 30%, the top 70%, and the bottom 30% in gains from each group saw similar trends of increased gains and lower treatment costs in the group that ingested carbon versus the control group. The top 30% in gains (i.e. 8 animals from each treatment group) were found to be 1.3% higher in ADG (1.821 versus 1.798) and treatment costs were lower by more than 50% ($4.20/head versus ($8.84/head). Results from the top 70% again favored use of sustainable carbon product with 1.643 ADG versus 1.613 and treatment cost of $5.60/head opposed to $6.25/head. The worst performers in term of gains from each group were analyzed (7 from each group) which yielded 35.9% increased ADG (1.303 versus 0.959) and $8.06/head treatment cost over $15.01/head—again favoring addition of sustainable carbon product to the milk replacer. Four calves failed to achieve 1.000 on average daily gain, all of which were in the non-carbon group.

When examining the ten most expensive calves in terms of individual treatment cost, Non-carbon calves were 4.3% heavier on entry (Average 96.0 lbs. versus 92.0 lbs.). These 10 calves were also $6.03/head more expensive to treat than their carbon fed counterparts. However, when these two subsets were weighed out on Day 42, the calves from the sustainable carbon product fed group gained an average of 5.3 lbs. (9.5%) more and had a higher ADG than the control group as shown in Table 2.

TABLE 2

| Sustainable Carbon Product | | | | | Non-Carbon | | | | |
|---|---|---|---|---|---|---|---|---|---|
| Avg. | Avg. | Avg. | Avg. | Tx | Avg. | Avg. | Avg. | Avg. | Tx |
| IN | Out | Gain | ADG | Cost | IN | Out | Gain | ADG | Cost |
| 92.0 | 152.9 | 60.9 | 1.450 | $131.96 | 96.0 | 151.6 | 55.6 | 1.324 | $192.33 |
| | 0.9% | 9.5% | 9.5% | $13.20/head | 4.3% | | | | $19.23/head |

Both groups had representatives in terms of calf diarrhea. In looking at the number of calves from each group that scored for diarrhea, there was very little difference—sustainable carbon-fed calves had 8 head scored and the control group had 9. Examination of daily observation records shows that all calves that scored for diarrhea, scored between day 0 and day 12 as is common in any commercial calf raising operation. Looking at a duration of scours—as defined by consecutive days scored for diarrhea—there was little difference between the groups. The average duration of scours for the carbon fed group was 1.25 days while the control group 1.46 days. Economic assessment of the calves that had associated fecal scores showed little difference with an average treatment cost of $10.12/head in the control group and $10.58/head in the treatment group.

A difference between the groups begins in examination of the severity/frequency of diarrhea and the day 42 weights. Scoring for calf diarrhea was assigned a numerical value with ‘0’ meaning the calf was passing normal feces. A score of ‘1’ was a mild diarrhea with some degree of associated consistency. A score of ‘2’ was the consistency of water and the highest on the scale. Of the 8 calves in the carbon treatment group, none were recorded with a score of ‘2’. Conversely, the control calves had 5 of their 9 representatives scored with a value of ‘2’ at least once, and some multiple times.

A tally of all fecal scores for the sustainable carbon-fed calves gives us ten entries among 8 calves with a combined numeric fecal score of 10. The control calves had twenty-two entries shared between 9 calves with a cumulative score of 27. This data set infers that frequency and severity of diarrhea were reduced in the treatment group.

In the calves that scored for diarrhea, the average in weight was 6.7 pounds greater in the control calves (90.7 lbs. versus 84.0 lbs). Remarkably, the sustainable carbon product fed calves made great strides on gains by day 42 over the once heavier control calves—posting 20.5% more average gain.

Control calves having scored for diarrhea finished on day 42 with an average gain of 48.7 lbs. (Three of the four calves that failed to attain an ADG of 1.000 were in this group). Those in the sustainable carbon product fed treatment group were 2.4% (3 lbs) heavier and finished with average gain of 58.6 lbs. This may be due to less observed frequency and severity of diarrhea in the calves fed sustainable carbon product.

### Example 2

A study was conducted to observe NDF disappearance (NDFD), volatile fatty acid (VFA) production, and methane gas output with supplementation of a sustainable carbon product in rumen fluid batch cultures. The treatments (Trt) were sustainable carbon product (CP) or sustainable carbon product with electrolytes (CPE). The diet provided was a high forage (HF) diet with concentrate pellets (33.3%), orchard grass (44.4%), alfalfa (22.2%), and either no supplemented fat or 3% dry matter (DM) as corn oil (CO). The CP and CPE were dosed (Inc) at either 0, 1, 2 or 4% of total DM. Separately, four round bottom flasks were used for gas production measurements because smaller culture tubes would not produce enough gas volume. The flasks were fed either HF or HF with CP at 2%. Data were analyzed utilizing PROC MIXED (v. 9.4, SAS Institute 2015) with the fixed effects of Trt, CO, Inc, and their interactions. The random effects were run and order of inoculation. CP did not decrease NDFD and with 2%−CO and 1%+CO, NDFD increased. CPE also did not decrease NDFD and with 1%−CO, 4%−CO, and 1%+CO, NDFD increased (P=0.07, Trt*CO*Inc). For total VFA production, CP increased the concentration with 2%−CO, 4%−CO, and 4%+CO. CPE also increased total VFA with 4%−CO and 4%+CO (P=0.02, Trt*CO*Inc). Although methane gas production was not significant, there was numerical reduction of 23.08 mg produced in 24 hours (P=0.16). Methane (g/kg NDFD) decreased (P=0.022) by 17.21 g/kg NDFD. A numerical decrease (P=0.23) of 0.10 mg/d was also seen in hydrogen gas production. Therefore, CP could reduce methane output without depressing NDFD and VFA when implemented as a feed additive. With the current stress on agricultural practices to decrease environmental impacts, feeding biochar as a methane mitigation strategy could be crucial to the dairy industry while simultaneously utilizing a waste product.

The experiment was conducted using a rumen fluid batch culture with 4 round bottom flasks and 72 culture tubes containing different diets, along with blanks. A total of two runs were conducted for this study. Preparation began a week before the batch culture was initiated. First, culture tubes were numbered (1-72) and were prepared by weighing out each feed ingredient. The culture tubes contained a total of 0.5 g DM. The high forage diet used is described in Table 3 consisted of a concentrate pelleted feed (33.3%) along with orchard grass (44.4%), alfalfa pellets (22.2%), and either no supplemented fat or 3% dry matter (DM) as com oil (CO). A high forage diet was used to increase methane production to ensure there was enough for sample collection. The treatments were CP and CPE. Either product was dosed at 0%, 1%, 2% and 4% DMI. Previous studies have included CP as 1-2% of DMI, but 4% inclusion was used to investigate whether there were negative effects at higher doses. At each level, 4 tubes had 3% DM as additional supplemental fat and 4 tubes did not. Four round-bottom flasks were also used to capture methane gas produced, containing a total of 10 g DM. The flasks were either dosed with CP at 2% inclusion rate or no treatment. Round bottom flasks were used because smaller culture tubes would not produce enough gas volume to measure methane production.

TABLE 3

| | | High Forage + Corn Oil |
|---|---|---|
| Ingredient (% DM) | High Forage | (CO) |
| Alfalfa | 22.22 | 22.22 |
| Orchard Grass | 44.44 | 44.44 |
| Corn Grain | 22.88 | 15.94 |
| Corn Starch | 0.00 | 5.00 |
| Dicalcium Phosphate | 0.20 | 0.20 |
| Magnesium Oxide | 0.10 | 1.40 |
| Selenium 200 | 0.14 | 0.14 |
| Soybean Hulls | 2.76 | 0.00 |
| Soybean Meal | 5.22 | 6.92 |
| TM Supplement | 0.50 | 0.50 |
| Vitamin (A, D, E) | 0.13 | 0.13 |
| Fat - Calcium Soaps | 1.40 | 1.40 |
| Fat - Vegetable Oil | 0.00 | 3.00 |
| Diet Composition (%) | | |
| DM | 92.40 | 92.69 |
| NDF | 38.83 | 38.17 |
| CP | 14.89 | 14.77 |
| RUP | 5.40 | 5.33 |
| RDP | 9.60 | 9.67 |
| Fat | 2.97 | 5.40 |
| Starch | 16.60 | 16.56 |

The diet was fed as ground alfalfa and orchard grass pellets, the remaining ingredients listed were mixed into a concentrate pellet that was ground before adding to the batch culture tubes or flasks. The buffer solution was prepared 24 hours before starting the batch culture. The media solution consisted of 2 L of distilled H2O, 5 mL of a micromineral solution (30 g CaCl_{2*2}H₂O, 8 g FeCl₃*6H₂O, 10 g MnCl₂*4H₂O, 1 g COCl₂*6H₂O, 100 mL distilled H₂O), 1 L of a macromineral solution (11.4 g Na₂HPO₄, 12.4 g KH₂PO₄, 1.2 g Mg₂SO₄, 2 L distilled H₂O), 1 L of a rumen buffer solution (78.94 g NaHCO₃, 2 L distilled H₂O), and 5 mL of 0.1% resazurin as an indicator of reduction. This was bubbled with CO₂ continuously for 24 hours. The media solution was used to help maintain pH within the test tubes and round bottom flasks.

On the morning of the initiation of the batch culture, 250 mL of the reducing media solution (3.125 g L-Cysteine HCl*H₂O, 20 mL 1N NaOH, 3.125 g Na₂S*9H₂O, 475 mL reduced distilled H₂O) was added to the media solution while rumen fluid was collected from a cannulated cow. This was done by squeezing rumen contents in a cheese cloth and collecting the rumen fluid in a funnel over a 250 mL container. Four containers were filled, and these were placed in a cooler with 39° C. water. This maintained the temperature of the rumen fluid until it was taken back to the lab. Next, the rumen fluid was placed in a blender to ensure that any large contents that got through the cheese cloth were pureed to a small particle size and filtered through cheesecloth. The rumen fluid was then added to a beaker with CO₂ gas to maintain the anaerobic environment. Prepared buffer solution was added to a large, rectangular shaped container and placed into a water bath at 39° C. with the shaker on. Rumen fluid was added in a ratio of 1-part rumen fluid to 3-parts buffer. A CO₂ gas line with a bubbler was added to the mixture in order to maintain the anaerobic environment. In a random order, batch culture tubes were dosed with 30 mL of combined rumen fluid/buffer solution every 2-3 minutes while the rumen fluid and buffer was continuously being mixed. Simultaneously, CO₂ was flowing into the culture tubes. A stopper was placed on each test tube with a one-way valve that releases pressure out of the tube but maintains an anaerobic environment inside of the tube. The main purpose of the culture tubes was to look at how corn oil and biochar affected nutrient digestibility, VFA production, and VFA profile. After the stopper was sealed on the culture tube, it was placed in a test tube rack in the incubator in the order of random selection. The round bottom flasks were also randomly inoculated in a random order with the batch culture tubes and dosed with 600 mL rumen fluid/buffer solution while simultaneously adding CO₂. A stopper with a one-way valve attached to a mylar balloon was placed on each round bottom flask. The volume of the balloon prior to incubation was measured by water displacement. A one-way valve ensured only the gas leaving the round bottom flask was captured in the mylar balloon without allowing pressure to increase in the flasks, and it maintained an anaerobic environment. The round bottom flasks were then placed in an incubator at 39° C. for 24 hours.

The batch culture was also incubated for a 24-hour time period. After 24 hours, samples were collected from the culture tubes and round bottom flasks in the order they were dosed with rumen fluid/buffer solution. The mylar balloon were detached from the round bottom flasks, and the final volume of the balloon was measured by water displacement. Gas samples from the balloons were tested by injecting the gas collected through a Micro-Oxymax Respirometer (Columbus Instruments Inc., Columbus, Ohio), which measures methane and hydrogen concentration.

Neutral detergent fiber was also measured after drying the batch culture tubes at 50° C. for approximately 2 days in an oven. The dried samples were scraped into 500-mL beakers that were combined with NDF solution. Reflux racks and a filtering system were used, followed by weighing back the NDF residue from the analysis.

Volatile fatty acids were tested by obtaining a 5-mL sample from the test tubes and round bottom flasks. After 24 hours, the tubes were then placed on ice to stop fermentation. The 5-mL subsamples were placed into a 15-mL test tube already prepared with 1 mL of 25% metaphosphoric acid that was made fresh that morning. The tubes were capped and vortexed and allowed to settle for 20 min. After settling, a 2-mL sample was pipetted into a 2-mL microtube, and the remaining sample was stored in a 5-mL microtube at −20° C. The 2-mL microtubes were centrifuged at 5,000×g for 15 min at 4° C. Without disturbing the pellet, 1.7 mL was pipetted to a new 2-mL microtube and stored at −20° C.; the previous tube was disposed. After the samples were completely frozen (left in the freezer at least overnight), the 2-mL microtube was allowed to thaw at room temperature. After thawing, 0.17 mL of 109 0.92 mM pivalic acid was added as the internal standard. The samples were vortexed and then centrifuged at 5,000×g for 15 min at 4° C., and the supernatant was transferred to a new 2-mL microtube. The tubes were refrozen at −20° C. (at least overnight), thawed at room temperature, vortexed, centrifuged at 5,000×g for 15 min at 4° C., and the supernatant was transferred to a new 2-mL microtube. This step was repeated until there was no pellet after centrifuging. After there was no pellet remaining in the sample, an additional 2-mL microtube was prepared with 1 mL of distilled H₂O and 0.4-mL sample. After vertexing the 2 mL microtube, the pH of the sample was tested with litmus paper and balanced to a pH of 6-7 with adding 4 N potassium hydroxide (KOH). Each sample was vortexed to mix prior to confirming the pH was neutral. The exact volume of 4 N KOH added was recorded and used to calculate the final dilution of the sample. From the neutral sample, 1 mL was added to a 2 mL gas chromatography (GC) vial with 0.1 mL of 0.3 oxalic acid, which was considered in the final dilution calculation. The vials were then capped, vortexed, and stored at −20° C. until the samples could be analyzed.

The VFA samples were analyzed with a splitless HP5890 GC equipped with a flame ionize detector (FID) and a 23110-U glass packed column (Sigma Aldrich St. Louis, Mo.). Nitrogen, the carrier gas, had a flow rate of 0.4 mL/s. The FID supply was H₂ (flow rate 0.5 mL/s) and air (>1 mL/s). The inlet was 150° C., the dectore was 180° C., and the initial temperature was 175° C. The initial temperature was held for 18 min, then increased to 195° C. at 25° C./min and was held for 10 minutes. At the beginning of the run, a standard curve was derived using an external standard (ES), which contained known concentrations of the acetate, propionate, isobutyrate, butyrate, IS, 2-methylbutyrate, isovalerate, valerate, and caproate, was used to confirm linearity. After every 10 samples, an ES sample (8.06 mM acetate, 2.72 mM propionate, 0.28 mM isobutyrate, 2.06 mM butyrate, 9.97 mM IS, 0.52 mM 2-methylbutyrate, 0.41 mM isovalerate, 0.41 mM valerate, 0.54 mM caproate) was injected and used to calculate a response factor for each VFA peak. Between each injection, a sample of distilled H₂O was injected and ran through the same conditions to maintain the column and prevent carryover between samples. After the samples were ran, the peaks were integrated, and total VFA concentration and individual VFA concentrations were calculated utilizing the following equations:

Relative Response Factor for Individual VFA (RRFvFA)=Area_{VFA(ES)}/[VFA]_{ES}×[IS]_{ES}/Area_{IS(ES)}, wherein Area_{VFA(ES)} is the area of the individual VFA in the ES, wherein Area_{IS(ES)} is the area of the IS in the ES, wherein [VFA]_{ES} is known concentration of the individual VFA in the ES, and wherein [IS]_{ES} is the known concentration of the IS in the ES.

Concentration of Individual VFA (mM)=AreaVFA(sample)/ArealS(sample)×1/RRFVFA×[IS]sample×MF, wherein AreaVFA(sample) is the area of the individual VFA in the dilated sample, wherein ArealS(sample) is the area of the IS in the diluted sample, wherein [IS]sample is the concentration of IS in the diluted sample, and wherein MF is multiplication factor to correct for the dilution of the sample with distilled H₂O, KOH, and oxalic acid.

The effect of CP, CPE, and CO on NDF disappearance and VFA production and profile were analyzed with PROC MIXED (v. 9.4, SAS Institute 2015). The model used was Yᵢⱼₖₗₘ=μ+Tᵢ+Iⱼ+Fₖ+(T×I)ᵢⱼ+(I×F)ⱼₖ+(T×F×I)ᵢⱼₖ+Oₗ+Rₘ+eᵢⱼₖₗₘ where Yᵢⱼₖₗₘ=response variable; μ=overall mean response; Tᵢ=the fix effect of treatment (i=1 or 2) where 1=CP and 2=CPE; Iⱼ=the fix effect of treatment inclusion (j=0, 1, 2, or 4) where 0=0% treatment inclusion, 1=1% treatment inclusion, 2=2% treatment inclusion, and 4=4% treatment inclusion; Fₖ=the fix effect of CO (k=0 or 1) where 0=no supplemented com oil, and 1=3% DM addition as corn oil); (T×I)ᵢⱼ=the interaction of treatment and inclusion; (I×F)ⱼₖ=the interaction of inclusion and CO; (T×F×I)ᵢⱼₖ=the interaction of treatment, inclusion, and CO; Oₗ=the random effects of order of inoculum (1=1-76); Rₘ=the random effect of run (m=1 or 2); and eᵢⱼₖₗₘ=residual error.

The effect of CP on gas production with the round bottom flasks was analyzed with PROC MIXED (v. 9.4, SAS Institute 2015). The model used was Yᵢₗₘ=μ+Iⱼ+Oₗ+Rₘ+eᵢₗₘ where Yᵢₗₘ=response variable, μ=overall mean response; Iⱼ=the fix effect of inclusion (j=0 or 2) where 0=no supplement and 2=CP at 2% inclusion, Oₗ=the random effects of order of inoculum (1=1-76), Rₘ=the random effect of run (m=I or 2).

From statistical model evaluation, residuals were normally distributed and there was homogeneity of variance. Significant differences were at P values of ≤0.05, and tendencies were at P values 0.05<P≤0.10. All data were expressed as LSM with SE.

Shown in FIG. 1, the overall disappearance of NDF (NDFD) did not change (P=0.53) with treatment; however, there was a three-way interaction between treatment with CP and CPE, fat supplementation and percent inclusion (P=0.068) for this measurement. As displayed in FIG. 1, there was an increase (P=0.0073) of NDF disappearance only at 2% inclusion of CP and no supplemental fat compared to the 0%−CO. With no supplemental fat and 1% or 4% inclusion of CPE, NDF disappearance increased (P<0.068), with the greatest change occurring at the 1% dose. The inclusion of supplemental fat and CP increased (P=0.065) NDFD at 1% inclusion. When there was supplemental fat and 1% inclusion of CPE, NDFD increased (P=0.041). Supplemental fat did not decrease NDFD and actually increased (P<0.10) the measurement at 1%, 2% CP compared to CP−CO at the same inclusions. At the CPE 2% inclusion, CO increased (P=0.08) NDFD.

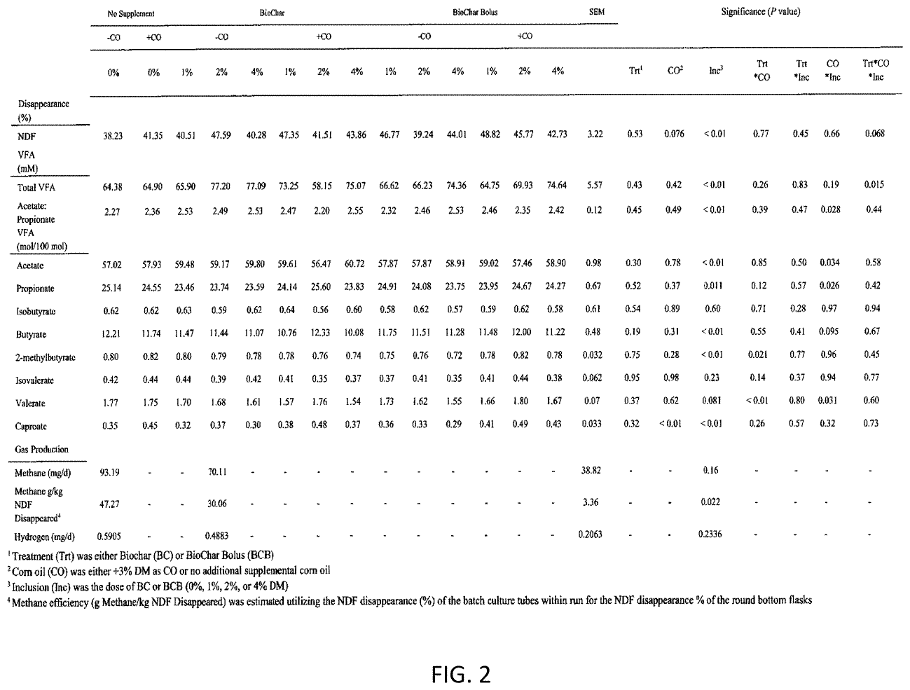

There was a three-way interaction between treatment with CP and CPE, CO, and inclusion (P=0.015) for total VFA concentration. As shown in FIG. 2, when CP with no CO was dosed at 2% or 4%, total VFA (mM) increased (P<0.0055) with the greatest improvement at the 2% compared to 0%−CO. Total VFA also increased (P=0.030) at 4% inclusion with CPE−CO. With CO and 1% or 4% inclusion of CP, total VFA (mM) increased (P<0.054). With CO and 4% inclusion of CPE, total VFA increased (P=0.028) compared to 0%+CO. Supplemental CO increased (P=0.0002) total VFA when added with CP 2% compared to 2% CP−CO.

Between CP and CPE, there were no differences (P=0.45) in the acetate: propionate. There was an interaction between inclusion and CO (P=0.028) for this measurement. When there was no supplemental fat, any inclusion level of CP and CPE increased (P<0.022) the ratio by 0.16-0.26. With supplemental fat and 1% or 2% inclusion of CP or CPE, there was no change (P>0.19) in the acetate: propionate, but at the 4% dose, the ratio increased (P=0.09) by 0.12. Additional CO increased (P=0.022) the ratio at 0% inclusion by 0.16, but it decreased (P=0.013) at the 2% inclusion by 0.20.

Acetate molar proportion had no differences (P=0.30) between CP and CPE treatment. There was an interaction between fat supplementation and percent inclusion (P=0.034). When fat was supplemented and 1% or 4% inclusion CP or CPE was dosed, acetate increased (P<0.088) by 1.7-2.7 mol/100 mol. However, with 2% CP or CPE inclusion, acetate molar proportion did not change (P=0.17). At the 2% inclusion supplemental CO decreased (P=0.0089) acetate by 2.16 mol/100 mol. Between CP and CPE, there were no differences (P=0.52) in propionate. There was an interaction between percent inclusion and CO (P=0.026). When there was no supplemental fat, any inclusion level of CP and CPE decreased (P<0.025) propionate by 0.96-1.5 mol/100 mol. With supplemental fat, there were no changes (P>0.15) with inclusion doses. Additionally, CO decreased (P=0.025) the proportion of propionate at the 0% and 2% inclusion. Isobutyrate molar concentration had no significant main effects or interactions (P>0.28). There were no differences (P=0.19) between treatment with CP and CPE on mol/100 mol butyrate. However, there was an interaction between supplemented fat and percent inclusion (P=0.095). When no fat was supplemented, any inclusion level of CP and CPE decreased (P<0.088) by 0.60-1.03 mol/100 mol. With fat supplementation, there were no changes (P>0.12) at 1% or 2% inclusion of CP or CPE; however, with 4% inclusion of CP or CPE, butyrate decreased (P=0.0038) by 1.07 mol/100 mol. Supplemental CO increased (P<0.10) the molar proportion of butyrate at the 0% and 2% inclusion of CP or CPE. As a proportion of total VFA, 2-methylbutyrate with I % or 4% inclusion with CP or CPE decreased (P<0.034) by 0.035-0.061 mol/100 mol compared to the batch culture tubes with 0%−CO. However, there were no changes (P=0.11) with 2% inclusion of CP or CPE. There was also an interaction between treatment with CP and CPE and fat supplementation (P=0.021). When no fat was supplemented, CPE decreased (P=0.061) 2-methylbutyrate by 0.032 mol/100 mol compared to CP−CO. There were no changes (P=0.16) between CP and CPE treatment with fat supplementation. Also, CO increased 2-methylbutyate molar proportion when added to CPE (P=0.021) by 0.04 mol/100 mol. Isovalerate did not display any significant main effects or interactions. There was an interaction between fat supplementation and percent inclusion for valerate as a proportion of total VFA (P=0.031). When there was no fat supplementation and 2% or 4% inclusion of CP or CPE, valerate decreased (P<0.016) by 0.18-0.19 mol/100 mol, whereas I % inclusion had no change (P=0.23) compared to 0%−CO. With fat supplementation and 1% or 4% inclusion with CP or CPE valerate decreased (P<0.0047) by 0.147-0.15 mol/100 mol. However, there were no changes with 2% inclusion of CP or CPE (P=0.65). Supplemental CO decreased (P=0.075) valerate at the I % and 2% dose of CP or CPE compared to 0%−CO. Additionally, there was an interaction between treatment with CP and CPE and fat supplementation. There were no differences (P=0.54) between CP and CPE treatment when no fat was supplemented, and supplemental CO did not affect (P>0.13) valerate with CP or CPE. With fat supplementation, CPE increased (P=0.064) valerate by 0.068 mol/100 mol compared to CP+CO. There were no differences (P=0.32) between treatment with CP and CPE on mol/100 mol caproate. As a proportion of total VFA, caproate with 1% or 4% inclusion with CP or CPE decreased (P<0.082) by 0.03-0.05, but 2% inclusion had no change (P=0.21). When fat was supplemented, caproate increased (P<0.001) by 0.10 mol/100 mol.

Although methane gas production was not significant, there was numerical reduction of 23.08 mg produced in 24 hours (P=0.16) with CP. Methane g/kg NDFD was estimated for the round bottom flasks using NDFD results of the batch culture tubes. This measurement decreased (P=0.022) by 17.21 g/kg NDFD with 2% CP. A numerical decrease (P=0.23) of 0.10 mg/d was also seen in hydrogen gas production with CP.

This study displayed no negative effects of corn oil (CO) or CP on NDFD. In certain cases, there were even increases in NDFD. The addition of supplemental fat and CP increased NDFD at the 1% and 2% inclusions when compared to CP−CO. There was also an increase in NDFD with CPE 2%+CO compared to CPE 2%−CO.

In this study, total VFA and the proportion of VFA were evaluated after the usage of CP or CPE in a rumen fluid batch culture. In total, VFA production did not decrease with CP, CPE, or CO supplementation. In fact, CP increased the total VFA concentration with 2% and 4% percent inclusion without fat supplementation, when compared to 0%−CO. Total VFA also increased 4% inclusion with CO. There were also increases in total VFA concentration with CPE. These increases were with 4% inclusion without CO supplementation and 4% inclusion with CO supplementation, when compared to 0% inclusion with CO. Supplemental CO also increased total VFA when it was added with CP 2% inclusion and compared to CP−CO.

In addition to increases in total VFA concentration, there was also an increase in acetate: propionate when fat was supplemented at 1% or 4% inclusion of CP or CPE. However, at 2% inclusion with fat supplementation, there were no changes in the acetate: propionate ratio. This ratio increase is primarily due to the increase in fiber digestibility. Acetate molar proportion had no differences between CP and CPE treatment; however, when fat was supplemented with 1% or 4% inclusion of CP or CPE, there was an increase in acetate by 1.7-2.7 mol/100 mol. This increase in acetate molar proportion differs from a previous study that compared different biomass sources as there were no changes in total VFA or acetic acid production during in vitro fermentation.

There were changes in the propionate molar proportion with the supplementation of CO and percent inclusion. This molar proportion decreased with any percent inclusion of CP or CPE when no fat was supplemented. However, when CO was supplemented, the proportion of propionate increased at the 0% and 2% inclusion of CP or CPE. This proportion most likely decreased due to increase in acetate molar proportion with 1%+CO and 2%+CO. Butyrate also decreased in this experiment when no CO supplementation was included and at any inclusion level of CP and CPE. With fat supplementation, the molar proportion increased at 0% and 2% inclusion; however, there was a decrease with 4% inclusion of CP or CPE. Therefore, with the addition of CO, more CP or CPE was needed to cause a decrease in the butyrate molar proportion. Butyrate producing bacterial also have a role in biohydrogenation bacteria; thus, the addition of corn oil may cause and increase in this process which results in an increase in butyrate. This change could also be due to decreases in the proportion of acetate with 2% CP or CPE inclusion and increases in acetate with I % or 4%; therefore, butyrate and acetate act inversely in some cases of CP inclusion.

Isobutyrate, 2-methylbutyrate, isovalerate (branched-chain volatile fatty acids, BCVFA) and valerate have been shown to be growth-promoting factors for rumen microbes, especially fiber digesting bacteria. There were no changes in isobutyrate and isovalerate with the study, however, there were differences in 2-methylbutyrate and valerate. For 2-methylbutyrate, there were differences between treatment with CP and CPE. CPE decreased the proportion of 2-mehtylbutryarte compared to CP, and when CO was added to CPE 2-methylbutyrate mol/100 mol increased. Similarly, with 1% and 4% inclusion of CP or CPE, 2-methylbuterate decreased as a proportion of total VFA. These decreases may be due to increased utilization of 2-methylbuterate for microbial growth. 2-methylbuterate is utilized for isoleucine synthesis in Prevotella ruminicola and by bacteria that cannot catabolize BCAA and must synthesize BCAA utilizing BCVF A. Ruminococcus flavefaciens also incorporated labeled CO₂ with isobutyrate, isovalerate, and 2-methylbutyrate into valine, leucine, and leucine, respectively, which documented reductive carboxylation Other strains that require BCVFA for growth of major bacteria groups in the rumen include Ruminococcus flavefaciens strain C-94, Ruminococcus flavefaciens strain Cla, Ruminococcus flavefaciens strain B34b, Ruminococcus albus strain 7, and Fibrobacter succinogenes.

For valerate, there were interactions between fat supplementation and percent inclusion. When no fat was supplemented, 1% inclusion did not change; however, 2% and 4% inclusion of CP or CPE decreased valerate mol/100 mol. There was also a decrease in valerate mol/100 mol when fat was supplemented with 1% and 2% inclusion of CP and CPE. This coincides with acetate molar proportion at 1% inclusion of CP and CPE with fat supplementation. At the 1% inclusion dose, acetate increased, but at 2% inclusion, acetate decreased which behaved the same as valerate with 2% inclusion. This decrease in valerate could be due to its utilization for growth in microbes such as Fibrobacter succinogenes, which requires valerate for growth and is used mainly in odd chain fatty acids and aldehydes. In Selenomonas ruminantium, when bacteria were incubated with 14C-valerate odd chain fatty acids were synthesized. When unlabeled, saturated fatty acids utilized valerate for fatty acid synthesis and it decreased. This shows the bacteria can utilize exogenous fatty acids for their membrane structure when provided with dietary fat instead of elongating valerate. This may partially explain why CO increased valerate mol/100 mol was added with CPE and why the effects of CPE or CP inclusions were not consistent in the two diets. As a proportion of total VFA, caproate decreased with 1% or 4% inclusion of CP or CPE, and CO supplementation caused caproate mol/100 mol to increase. This increase with CO supplementation could result from bacteria utilizing the exogenous fatty acids instead of elongating more VFA for microbial membrane structure. Like valerate when unlabeled saturated fatty acids were added, S. ruminantium utilized caproate less for fatty acid synthesis. This could explain why supplemental CO increased the molar proportion of caproate as less was used for microbial membranes.

Although methane gas production was not significant, there was numerical reduction of 23.08 mg produced in 24 hours (P=0.16). In addition to decreases in methane, a numerical decrease (P=0.23) of 0.10 mg/d was also seen in hydrogen gas production. In conclusion, CP could reduce methane output without depressing NDFD and VFA when implemented as a feed additive. With the current stress on agricultural practices to decrease environmental impacts, feeding CP as a methane mitigation strategy could be crucial to the dairy industry while simultaneously utilizing a waste product.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein, but are to be accorded the widest scope consistent with this disclosure, the principles and the novel features disclosed herein.

What is claimed is:

1. A method for supplementing animal feed using a sustainable carbon product, the method comprising:
obtaining the sustainable carbon product from a process comprising:
obtaining a biomass feedstock;
feeding the biomass feedstock to a gasification or pyrolysis system; and
gasifying or pyrolyzing the biomass feedstock in the gasification or pyrolysis system to produce a gas and the sustainable carbon product; and
adding between 1.0 g and 10.0 g of the sustainable carbon product per day into the animal feed for an animal.

2. The method of claim 1, wherein the biomass comprises softwood, hardwood, nut shells, coconut shell, or hemp.

3. The method of claim 1, wherein the sustainable carbon product comprises at least 70% carbon by weight.

4. The method of claim 1, wherein the sustainable carbon product comprises at least 85% carbon by weight.

5. The method of claim 1, wherein the sustainable carbon product comprises less than 10% ash by weight.

6. The method of claim 1, wherein the sustainable carbon product comprises less than 12% H₂O by weight.

7. The method of claim 1, wherein the sustainable carbon product comprises a powder having an average particle size of greater than 70 microns or less than 40 microns.

8. The method of claim 1, wherein the sustainable carbon product comprises one or more of hydrogen, nitrogen, sulfur and oxygen.

9. The method of claim 1, wherein the sustainable carbon product comprises substantially no heavy metals or pesticides.

10. The method of claim 1, wherein the process comprises a carbon neutral or carbon positive process.

11. The method of claim 1, further comprising adding electrolytes to the obtained sustainable carbon product with prior to adding the sustainable carbon product into the animal feed.

12. The method of claim 1, wherein the gasifying or pyrolyzing the biomass feedstock comprises exposing the biomass feedstock to a temperature above 700° C. substantially in the absence of oxygen or air.

13. The method of claim 1, further comprising adding bentonite to the sustainable carbon product prior to adding the sustainable carbon product into the animal feed.

14. The method of claim 14, further comprising adding one or more of probiotics, Xantham gum, potassium sorbate, and water to the sustainable carbon product prior to adding the sustainable carbon product into the animal feed.

15. The method of claim 1, wherein the animal feed comprises a communal or pooled animal feed for a plurality of animals and between 1.0 g and 10.0 g of the sustainable carbon product is added to the animal feed per animal per day.

16. The method of claim 1, wherein the animal feed comprises an individual animal feed for a single animal and 1.0 g to 10.0 g of the sustainable carbon product is added to the animal feed per day.

17. The method of claim 1, wherein the animal comprises an animal from the biological subfamily Bovinae.

18. The method of claim 1, wherein the animal comprises a lactating animal or an animal less than 150 days old.

19. The method of claim 1, wherein between 1.0 g and 10.0 g of the sustainable carbon product is added per day into the animal feed for the animal for between 20 and 30 days after birth of the animal.

20. The method of claim 1, wherein the pre-mixed sustainable carbon product is added into the animal feed by pre-mixing such as to provide a uniform mix of the sustainable carbon product and the animal feed.
